(19) United States
(12) Patent Application Publication
(10) Pub. No.: US 2023/0203814 A1
(43) Pub. Date: Jun. 29, 2023

(54) SHINGLES HAVING OVERPRESSED NAILING ZONES AND METHODS FOR MAKING THE SAME

(71) Applicant: CertainTeed LLC, Malvern, PA (US)

(72) Inventor: Gregory F. Jacobs, Sullivan, ME (US)

(21) Appl. No.: 18/090,294

(22) Filed: Dec. 28, 2022

Related U.S. Application Data
(60) Provisional application No. 63/309,107, filed on Feb. 11, 2022.
(60) Provisional application No. 63/294,667, filed on Dec. 29, 2021.

(51) Int. Cl. E04D 1/28; E04D 1/26; B32B 3/30

(52) U.S. Cl. CPC E04D 1/28; E04D 1/26; B32B 3/30; E04D 2001/005

(57) ABSTRACT

The present disclosure relates particularly to a laminated roofing shingle that comprises a nailing zone in which the roofing granules in that nailing zone have been overpressed into the underlying bituminous substrate creating a visually distinct overpressed nailing zone.

### CROSS-REFERENCE TO RELATED APPLICATIONS

This application claims the benefit of priority of U.S. Provisional Patent Application No. 63/294,667, filed Dec. 29, 2021, and U.S. Provisional Patent Application No. 63/309,107, filed Feb. 11, 2022, each of which is hereby incorporated herein by reference in its entirety.

### BACKGROUND OF THE DISCLOSURE

### 1. Field of the Invention

The present disclosure relates generally to roofing products, for example, shingles suitable for covering and protecting the roofs of houses, buildings, and other structures. The present disclosure relates more particularly to roofing products having an improved nailing zone, specifically, a nailing zone that is visibly overpressed such that the roofing granules in the overpressed nailing zone are noticeably more embedded than those in the standard pressed zones of the shingle.

### 2. Technical Background

Due to their durability and hydrophobic properties, asphalts make excellent sealants and have a wide array of uses in construction applications. Asphalt-based roofing materials, such as roofing shingles, roll roofing and commercial roofing, are installed on the roofs of buildings to provide protection from the elements, and to give the roof an aesthetically pleasing look. Typically, the roofing material is constructed of a substrate such as a glass fiber mat or an organic felt, an asphalt coating on the substrate, and a surface layer of granules embedded in the asphalt coating.

A common method for the manufacture of asphalt shingles is the production of a continuous sheet of asphalt material followed by a shingle cutting operation which cuts the material into individual shingles. In the production of asphalt sheet material, either a glass fiber mat or an organic felt mat is passed through a coater containing hot liquid asphalt to form a tacky, asphalt coated sheet. Subsequently, the hot asphalt coated sheet is passed beneath one or more granule applicators which discharge protective and decorative surface granules onto portions of the asphalt sheet material.

In certain types of shingles, it is especially desired that the shingles define a sufficiently wide area, often known in the industry as the “nailing zone,” in order to make installation of roofs using shingles, such as laminated shingles, more efficient and secure. One or more lines or other indicia painted or otherwise marked longitudinally on the surface of the shingle may define such a nailing zone. It is especially desired that the shingles define a nailing zone that allows the installers to have some latitude in the nail placement.

A number of ways have been suggested to delineate a nailing zone of a shingle. For example, paint, ink or other markings can be used. One recent suggestion has been to abrade granules in the nailing zone to provide a visible indication. However, there are a number of disadvantages associated with these techniques for a number of reasons.

### SUMMARY OF THE DISCLOSURE

One aspect of the disclosure is a roofing shingle having a headlap portion and a top surface,
wherein the roofing shingle includes an overpressed nailing zone disposed on the top surface of the shingle in the headlap portion thereof, a first adjacent zone on the top surface of the shingle adjacent to and in an up-shingle direction from the overpressed nailing zone, and a second adjacent zone disposed on the top surface of the shingle adjacent to and in an down-shingle direction from the overpressed nailing zone, the first and second adjacent zones being 5 mm in height; and
wherein the roofing granules include a first plurality of roofing granules disposed in the overpressed nailing zone; a second plurality of granules disposed in the first adjacent zone; and a third plurality of granules disposed in the second adjacent zone; and
wherein the first plurality of roofing granules are embedded in a bituminous top surface of the shingle in a visually distinct manner as compared to (e.g., more deeply than) the second plurality of roofing granules and the third plurality of roofing granules.

In various embodiments, the roofing shingle is a roofing shingle is a laminated roofing shingle comprising
an underlay sheet having a top surface;
an overlay sheet having a bituminous top surface and a bottom surface bonded to the top surface of the underlay sheet, the overlay sheet comprising a tab portion comprising at least one tab and at least one cutout, and a headlap portion, the overlay sheet further comprising roofing granules disposed on the bituminous top surface;
wherein the laminated roofing shingle includes an overpressed nailing zone disposed on the top surface of the overlay sheet overlapping a region of the headlap portion in which the underlay sheet and the overlay sheet overlap, a first adjacent zone on the top surface of the overlay sheet adjacent to and in an up-shingle direction from the overpressed nailing zone, and a second adjacent zone disposed on the top surface of the overlay sheet adjacent to and in an down-shingle direction from the overpressed nailing zone, the first and second adjacent zones being 5 mm in height; and
wherein the roofing granules include a first plurality of roofing granules disposed in the overpressed nailing zone; a second plurality of granules disposed in the first adjacent zone of the overlay sheet; and a third plurality of granules disposed in the second adjacent zone of the overlay sheet; and
wherein the first plurality of roofing granules are embedded in the bituminous top surface of the overlay sheet in a visually distinct manner as compared to (e.g., more deeply than) the second plurality of roofing granules and the third plurality of roofing granules.

Another aspect of the disclosure is a method of making a laminated roofing shingle as described herein, the method comprising:
disposing granules on a top surface of a bituminous substrate, including
   a first plurality of granules in a nailing zone disposed in a region of the headlap portion (e.g., a region in which an underlay sheet and an overlay sheet overlap),
   a second plurality of granules in a first adjacent zone disposed on the bituminous top surface adjacent to and in an up-shingle direction from the nailing zone, and
   a third plurality of granules in a second adjacent zone disposed on the bituminous top surface adjacent to and in a down-shingle direction from the nailing zone; and
pressing the granules into the top surface of the bituminous substrate, to form an overpressed nailing zone in which the first plurality of roofing granules are embedded in the bituminous top surface in a visually distinct manner as compared to (e.g., more deeply than) the second plurality of roofing granules and the third plurality of roofing granules; and
forming the granule-coated bituminous substrate into a roofing shingle having the overpressed nailing zone at a top surface in a headlap zone thereof.
   As an example, the bituminous substrate can be in the form of an overlay sheet, and forming the granule-coated bituminous substrate into a roofing shingle can include bonding the overlay sheet to an underlay sheet.

The roofing shingles and methods of making described herein can result in a number of advantages. The overpressed nailing zone provides a visual indicator to a person of ordinary skill in the art of where to drive a fastener to ensure that the laminated roofing shingle is properly secured to a roofing structure. Overpressing roofing granules in the nailing zone offers a more attractive means of indicating a nailing zone than other conventional methods such as abrading, affixing tapes, or marking with paint or ink. Conventional marking methods require additional materials and process steps that add costs towards the manufacturing process. Also, abrading methods result in removing material that has already been applied to the shingle and requires such byproducts of the abrading process to be accounted for and reincorporated into the manufacturing process. Additionally, abrasion in particular causes the unavoidable release of dust particulates that may be harmful if inhaled and may also tend to clog up mechanical parts of a production line. Inevitably, abrasion techniques require manufacturers to take additional steps to contain, collect, and limit abraded dust particulates. Overpressing a visual nailing zone provides advances over the prior art because it allows for the shingle manufacturing process to continuously move forward, does not remove components that have been previously added, and does not result in the creation of additional byproducts or dust particulates.

### BRIEF DESCRIPTION OF THE DRAWINGS

The accompanying drawings are not necessarily to scale, and sizes of various elements can be distorted for clarity.

FIG. 1 provides a schematic exploded view and a schematic plan view, and FIG. 2 provides a schematic cross-sectional view of a roofing shingle according to one aspect of the disclosure.

FIG. 3 provides a close-up schematic cross-sectional view of an embedded granule.

FIG. 4 provides a close-up schematic cross-sectional view of an embedded granule that has been pressed at an angle.

FIG. 5 is a schematic plan view of a roofing shingle according to one embodiment of the disclosure.

FIG. 6 is a schematic plan view of a roofing shingle according to another embodiment of the disclosure.

FIG. 7 is a schematic cross-sectional view of a roofing shingle according to another embodiment of the disclosure.

FIG. 8 is a schematic plan view of a roofing shingle with a sinusoidal overpressed nailing zone according to another embodiment of the disclosure.

FIG. 9 is a schematic plan view of a roof according to one aspect of the disclosure.

### DETAILED DESCRIPTION

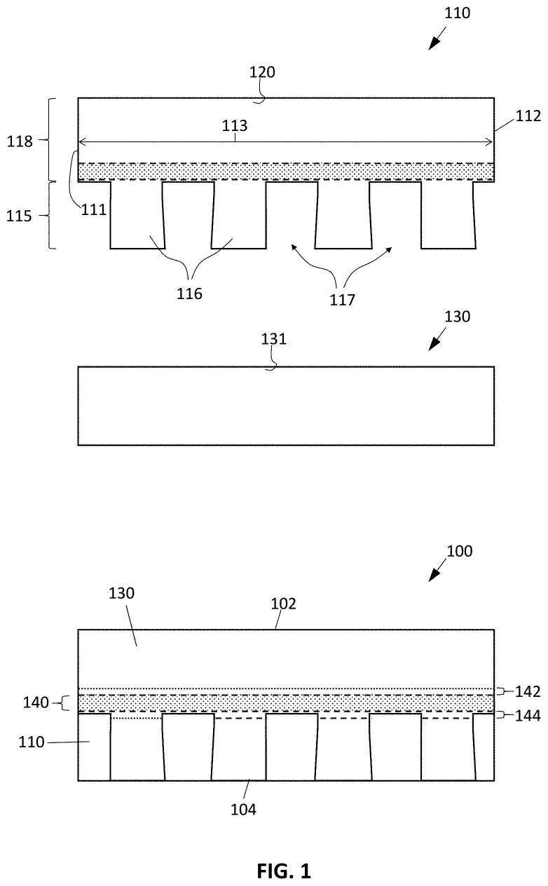

One embodiment of a roofing shingle according to the present disclosure is shown in schematic plan view in both exploded view and assembled view in FIG. 1, and in cross-sectional view in FIG. 2. The roofing shingle 100 includes an overlay sheet 110 which has a first lateral side 111, a second lateral side 112 and a width 113 measured from the first lateral side 111 to the second lateral side 112. The overlay sheet includes a tab portion 115 that includes at least one tab (e.g., a plurality of tabs) 116 and at least one cutout (e.g., a plurality of cutouts) 117, as well as a headlap portion 118. The person of ordinary skill in the art will appreciate that any desired number of tabs can be used, e.g., one, two, three, four, five, six, seven, eight, nine or ten tabs. The overlay sheet has a bituminous top surface 120, and further includes comprising roofing granules (not shown in FIG. 1 for purposes of clarity) disposed on the bituminous top surface.

The roofing shingle 100 also includes an underlay sheet 130. In the laminated shingle, the overlay sheet has a bottom surface 121 that is bonded to a top surface 131 of the underlay sheet. In the embodiment of FIGS. 1 and 2, the underlay sheet is under the tab portion of the overlay and extends somewhat into the headlap zone, as is common for laminated shingles. But other architectures are possible.

Notably, the roofing shingle includes an overpressed nailing zone 140 disposed on the bituminous top surface 120 of the overlay sheet 110. The overpressed nailing zone overlaps a region of the headlap portion in which the underlay sheet 130 and the overlay sheet 110 overlap. The roofing shingle also includes a first adjacent zone 142 on the top surface of the overlay sheet adjacent to and in an up-shingle direction from the overpressed nailing zone; and a second adjacent zone 144 disposed on the top surface of the overlay sheet adjacent to and in a-down-shingle direction from the overpressed nailing zone. Each of the first and second adjacent zones are 5 mm in height (i.e., in a direction from an upper edge 102 to a lower edge 104 of the shingle. The first adjacent zone and the second adjacent zone need not be distinguishable on the surface of the shingle; rather, they simply define zones for comparison with the overpressed nailing zone as described below.

The roofing granules 150 include a first plurality of roofing granules 152 disposed in the overpressed nailing zone; a second plurality of granules 154 disposed in the first adjacent zone of the overlay sheet; and a third plurality of granules 156 disposed in the second adjacent zone of the overlay sheet. Notably, the first plurality of roofing granules 152 are embedded more deeply in the bituminous top surface of the overlay sheet than the second plurality of roofing granules 154 and the third plurality of roofing granules 156. This is indicated by the dotted lines indicating the different surface levels of the granules. This difference in height is sufficient to be visible to an installer, and as such can visually delineate the nailing zone, i.e., a region of the shingle through which fasteners (e.g., nails, screws) are to be driven to attach the shingle to a roof.

In the embodiment of FIGS. 1 and 2, the roofing shingle is a laminated roofing shingle. However, the person of ordinary skill in the art will appreciate that other granule-coated roofing shingle architectures can be used, for example, single-layer architectures such as the conventional “three-tab” architecture. FIGS. 1 and 2 more generally exemplify a roofing shingle 100 that has top surface (here, top surface 120 of overlay sheet 110) and a headlap portion (here, headlap portion 118 of the overlay sheet). The roofing shingle includes an overpressed nailing zone 140 disposed on the top surface of the shingle in the headlap portion thereof, a first adjacent zone 142 on the top surface of the shingle adjacent to and in an up-shingle direction from the overpressed nailing zone, and a second adjacent zone 144 disposed on the top surface of the shingle adjacent to and in a down-shingle direction from the overpressed nailing zone, the first and second adjacent zones being 5 mm in height. The roofing granules 150 include a first plurality of roofing granules disposed in the overpressed nailing zone; a second plurality of granules disposed in the first adjacent zone; and a third plurality of granules disposed in the second adjacent zone. The first plurality of roofing granules are embedded in the bituminous of the top surface in a visually distinct manner as compared to (e.g., more deeply than) the second plurality of roofing granules and the third plurality of roofing granules.

In various embodiments, the granules in the overpressed zone are embedded more deeply than the granules in the first and second adjacent zones.

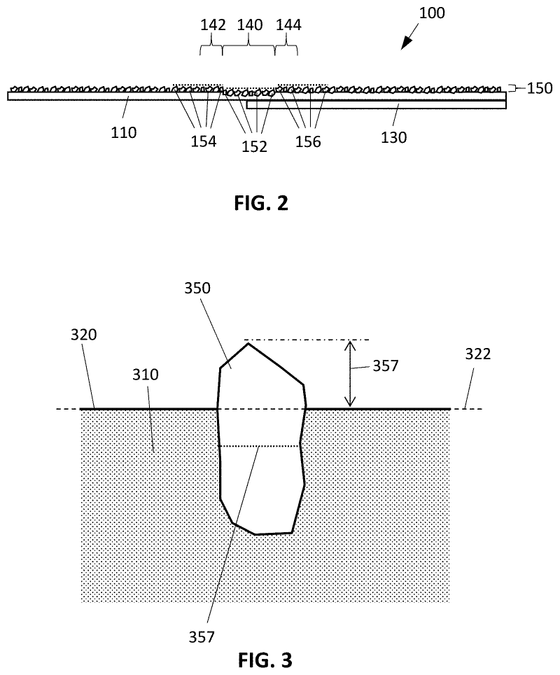

In various embodiments as otherwise described herein, in the overpressed nailing zone an average granule embed volume fraction is at least 0.5. FIG. 3 provides a close-up schematic cross-sectional view of an embedded granule. Granule 350 is embedded in a top bituminous surface 320, here, of an overlay sheet 310. The top surface 320 of the overlay sheet is demarcated by the dashed line 322. A plane parallel to the surface of the bituminous top surface that separates the top half of the granule from the bottom half of the granule by volume is demarcated by dotted line 357. Notably, the plane of half-volume is lower than the bituminous top surface; accordingly, embed volume fraction for this particle is greater than 50%. According to this embodiment of the disclosure, the average embed volume fraction over all granules in the overpressed nailing zone is at least 0.5 In certain embodiments, the granules are embedded even more deeply. And, in various embodiments, the roofing granules in the over-pressed zone are embedded in the bituminous top surface so that the average granule embed volume fraction is at least 0.7. In one embodiment, the roofing granules in the over-pressed zone are embedded in the bituminous top surface so that the average granule embed volume fraction is at least 0.85.

Desirably, the average granule embed fraction in the first and/or second adjacent zones can be substantially less than in the overpressed nailing zone. For example, in various embodiments as otherwise described herein, the first and/or second adjacent zones an average granule embed volume fraction is at least 0.15 less (e.g., at least 0.2 less) than an average granule embed volume fraction of the overpressed nailing zone. In various embodiments as otherwise described herein, in the first and/or second adjacent zones an average granule embed volume fraction is at least 0.25 less (e.g., at least 0.3 less) than an average granule embed volume fraction of the overpressed nailing zone.

Additionally or alternatively to granule embed volume fraction, the overpressed nail zone can be characterized by a distance of from the tops of the granules to the bituminous top surface. This distance is shown in FIG. 3 by arrow 357. In certain embodiments as otherwise described herein, in the overpressed nailing zone, the average distance between the tops of the roofing granules and the bituminous top surface is 1.0 mm or less. In certain embodiments as otherwise described herein, the average distance between the tops of the roofing granules and the bituminous top surface is 0.7 mm or less. In certain embodiments as otherwise described herein, in the overpressed nailing zone, an average distance between the tops of the roofing granules and the bituminous top surface is 0.5 mm or less (e.g., 0.2 mm or less).

Desirably, average distance between the tops of the roofing granules and the bituminous top surface in the first and/or second adjacent zones can be substantially more than in the overpressed nailing zone. For example, in various embodiments as otherwise described herein, in the first and/or second adjacent zones an average distance between the tops of the roofing granules and the bituminous top surface is at least 0.2 mm more (e.g. at least 0.3 mm more) than an average distance between the tops of the roofing granules and the bituminous top surface in the overpressed nailing zone. In various embodiments as otherwise described herein, in the first and/or second adjacent zones an average distance between the tops of the roofing granules and the bituminous top surface is at least 0.4 mm more (e.g. at least 0.5 mm more) than an average distance between the tops of the roofing granules and the bituminous top surface in the overpressed nailing zone.

Additionally or alternatively to granule embed volume fraction and distance from tops of granules to bituminous top surface, rub testing according to ASTM D-4977 can be used to characterize the embed depths of the granules. The ASTM D 4977 standard, entitled “Standard Test Method for Granule Adhesion to Mineral Surfaced Roofing by Abrasion is hereby incorporated herein by reference in its entirety. The rub test can be performed using a 3M Granule Adhesion Test Apparatus. The rub test measures granule loss after contact abrasion with a specified wire brush attached to a metal head of fixed weight with the brush in contact with the shingle top granule surface. There are 50 cycles to the test. One cycle is a forward and back motion. A pre-determined sample is weighed before and after the 50 cycles to determine any weight loss. As the person of ordinary skill in the art will appreciate, regions with deeper-embedded granules will have less loss in a rub test. In certain embodiments as otherwise described herein, the overpressed nailing zone exhibits a 0.30 gram loss or less in a rub test as described in ASTM D-4977. In certain embodiments as otherwise described herein, the over-pressed zone exhibits a 0.20 gram loss or less in a rub test as described in ASTM D-4977. In certain embodiments as otherwise described herein, the over-pressed zone exhibits a 0.10 gram loss or less in a rub test as described in ASTM D-4977.

The rub test for the first and/or second adjacent zones can provide greater loss values than for the overpressed nailing zone. For example, in various embodiments as otherwise described herein, the first and/or second adjacent zones exhibits a loss in a rub test as described in ASTM D-4977 that is at least 0.2 grams more (e.g., at least 0.25 grams more) than a loss exhibited by the overpressed nailing zone. In various embodiments as otherwise described herein, the first and/or second adjacent zones exhibits a loss in a rub test as described in ASTM D-4977 that is at least 0.3 grams more (e.g., at least 0.35 grams more) than a loss exhibited by the overpressed nailing zone.

Notably, the perceived height difference between the overpressed nailing zone and the first and second adjacent zones can provide sufficient visual contrast to identify the nailing zone to an installer. Accordingly, this can be the only difference between the zones. For example, in various embodiments as otherwise described herein, the first plurality of granules are of substantially the same color and distribution as the second and/or third pluralities of granules. In various embodiments as otherwise described herein, an overall surfacing of the overpressed nailing zone is substantially the same as an overall surfacing of the first adjacent zone and an overall surfacing of a second adjacent zone, i.e., the type and distribution of granules and other matter disposed on the bituminous top surface is substantially the in the overpressed nailing zone as in the first and second adjacent zones.

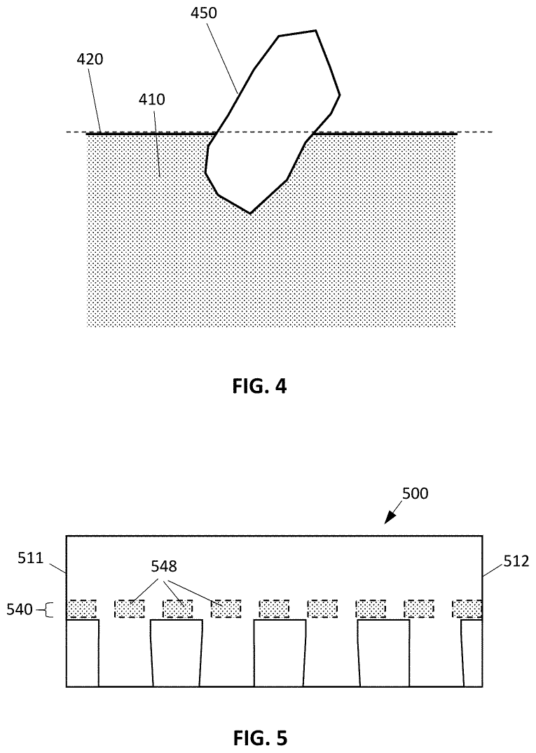

While in the embodiments of FIGS. 1 and 2 the granules in the overpressed zone are embedded more deeply than the granules in the first and second adjacent zones, other manners of differently-embedding granules can be used to provide a visible distinction between the overpressed zone and the first and second adjacent zones. For example, in some embodiments, the granules in the overpressed nailing zone are embedded with a visually-different average orientation as compared to the first and second adjacent zones. FIG. 4 provides a close-up schematic cross-sectional view of an embedded granule 450 that is embedded in bituminous surface 420, here, of an overlay sheet 410, oriented at an angle different from the angle of the granule in FIG. 3. Zones of granules with different average orientations can provide a visually distinct appearance, even in cases where the granules are all at about the same embed depth. As described in more detail below, rolling techniques can be used to provide an overpressed nailing zone with a different overall angular orientation as compared to the first and second adjacent zones.

The overpressed nailing zone can be configured in a number of fashions on the shingle (e.g., on an overlay sheet of a laminated shingle). For example, in various embodiments as otherwise described herein, the overpressed nailing zone extends substantially from a first lateral edge of the shingle or overlay sheet to an opposing second lateral edge of the shingle or overlay sheet. This configuration is shown, for example, in FIG. 1. In other embodiments, the overpressed nailing zone does not extend substantially from a first lateral edge of the shingle or overlay sheet to an opposing second lateral edge of the shingle or overlay sheet. For example, in various such embodiments, the overpressed nailing zone includes a plurality of separate overpressed segments extending along a width of the shingle or overlay sheet. Such an embodiment is shown in schematic plan view in FIG. 5. Roofing shingle 500 includes an overpressed nailing zone 540 that includes a plurality of separate segments 548, extending along a width of the shingle or overlay sheet from first lateral edge 511 to second lateral edge 512.

The overpressed nailing zone can have any desirable height, i.e., in an up-shingle to down-shingle direction. For example, in various embodiments, the overpressed nailing zone has a height measured in an up-shingle to down-shingle direction in the range of 10 mm to 50 mm.

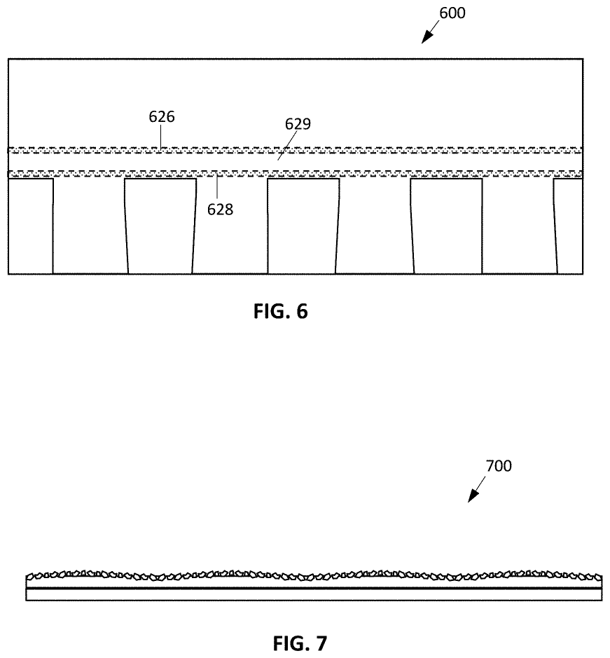

Another embodiment of a roofing shingle according to the disclosure is shown in schematic plan view in FIG. 6. Here, instead of using overpressed granules to indicate the entire area suitable for nailing, the shingle includes two separate overpressed features indicating upper and lower boundaries of a nailing area. The overpressed nailing zone of laminated roofing shingle 600 includes a first region 626 and a second region 628 disposed in a down-shingle direction from the region. The first region and the second region define therebetween a non-overpressed nailing zone 629. The non-overpressed nailing zone can have, for example, a height measured in an up-shingle to down-shingle direction in the range of 10 mm to 50 mm. The first and second regions of the overpressed nailing zone can have, for example, heights measured in an up-shingle to down-shingle direction in the range of 3 mm to 20 mm.

While the shape of the overpressed nailing zones are shown in the figures as being rectangular, the person of ordinary skill in the art will appreciate that other shapes can be used.

In various embodiments, e.g., as shown in FIG. 2, the first plurality of granules are substantially uniformly pressed into the top surface of the shingle throughout the overpressed nailing zone. However, in other embodiments, the first plurality of granules are pressed into the top surface of the shingle with varying profiles along a width of the shingle. This is shown in the cross-sectional view of FIG. 7 (taken along the width of the shingle 700 in the overpressed nailing zone). In the more overpressed areas the difference with respect to the first and second adjacent zones will be more noticeable; the person of ordinary skill in the art can thus understand the boundaries of the nailing zone.

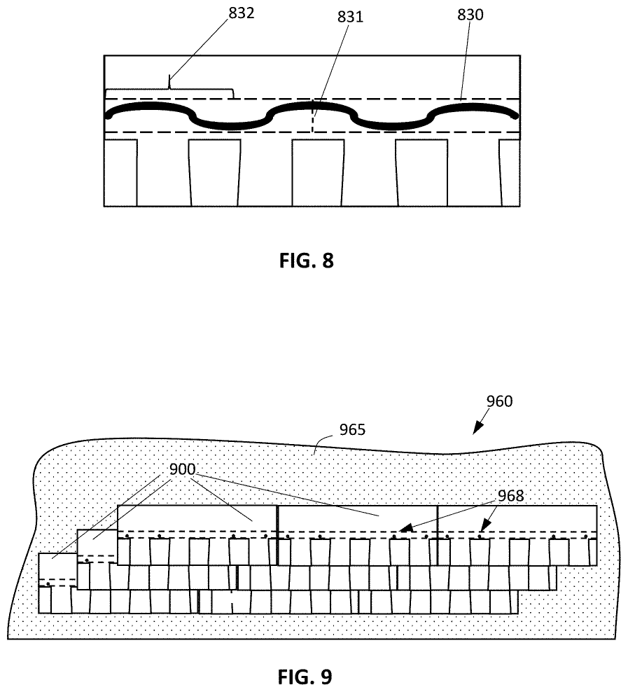

In yet another embodiment, the overpressed nailing zone is defined by some other pattern of differently-embedded granules. The pattern need not fill space from an upper edge to a lower edge of the overpressed nailing zone, as long as it indicates the extent of the nailing zone in such direction. For example, in various embodiments, differently-embedded granules in the overpressed nailing zone are formed in a periodic wave form pattern 830 as shown in FIG. 8. The amplitude 831 is the height of the nailing zone, and the period 832 of the wave from would repeat across the length of the shingle. The waveform may be regular or irregular. Any desired shape can be used, e.g., sinusoidal or a transformation thereof, saw tooth, triangular, or square. The wave form pattern may be achieved by multiple pressing techniques such as a stamping-press, or alternatively by a rolling embossing drum.

Roofing shingles are familiar to the person of ordinary skill in the art, and the person of ordinary skill in the art can use any desirable architecture consistent with the description herein. In various embodiments the roofing shingles of the disclosure are rectangular. But other shapes (e.g., parallelogram) are possible.

Shingle layers such as a single shingle layer, an overlay sheet and an underlay sheet can be based on bituminous roofing substrates, which are generally familiar to the person of skill in the art. Bituminous roofing substrates are often provided in sheet form, as one or more layers of glass mat, felt or fabric impregnated with bituminous material such as asphalt. Notably, in certain embodiments (especially those in which the bituminous roofing substrate includes a glass mat), the person of skill in the art will ensure that the thickness of the bituminous material is thick enough so that the relatively deeply-embedded particles do not substantially contact the impregnated layers. The bituminous material can also or alternatively be filled with fibrous or particulate matter, as is familiar to the person of skill in the art.

A variety of types of roofing granules may be used in practicing various aspects of the present disclosure. Roofing granules may be made from virtually any material that will withstand exposure to the environment without substantially degrading over a period of years, e.g., rock, mineral, gravel, sand, ceramic, or plastic. In certain embodiments of the disclosure, the granules are ceramic-coated mineral core particles optionally colored with metal oxides, such as those conventionally used on asphalt roofing shingles. The mineral core can consist of any chemically inert matter that can support a ceramic layer and has adequate mechanical properties. The mineral particles, which can be produced by a series of quarrying, crushing, and screening operations, are generally intermediate between sand and gravel in size (that is, between about 8 US mesh and 70 US mesh), and can, for example, have an average particle size of from about 0.2 mm to about 3 mm, and more preferably from about 0.4 mm to about 2.4 mm. In particular, suitably sized particles of naturally occurring materials such as talc, slag, granite, silica sand, greenstone, andesite, porphyry, marble, syenite, rhyolite, diabase, greystone, quartz, slate, trap rock, basalt, and marine shells can be used, as well as recycled manufactured materials such as crushed bricks, concrete, porcelain, ceramic grog, ground recycled tires and fire clay. Other materials, such as natural mineral matter (e.g., sand, crushed rock, and the materials listed above as suitable for the cores of coated granules), polymeric granules, and other synthetic materials can also be used. Polymeric materials, for example, can be provided with a variety of shapes (e.g., spherical, angular, sub-angular), which can contribute, in whole or in part, to the desired appearance.

In various embodiments as otherwise described herein, the granules are disposed on the bituminous roofing substrate in the overpressed nailing zone with a surface fill factor of greater than about 60%. The surface fill factor is the fraction of the zone that is occluded by the granules, as measured in a direction normal to surface. Desirably, the granules have a surface fill factor of greater than about 75%. In certain desirable embodiments of the disclosure, the granules have a surface fill factor of greater than about 85%. Granule surface coverage can be measured using image analysis software, namely, Image-Pro Plus from Media Cybernetics, Inc., Silver Spring, Md. 20910. The shingle surface area is recorded in a black and white image using a CCD camera fitted to a microscope. The image is then separated into a bituminous coating portion and a granule covering portion using the threshold method in gray scale. The amount of granule coverage is then calculated by the image analysis software based upon the number of pixels with gray scale above the threshold level divided by the total number of pixels in the image. As the person of skill will recognize, in certain embodiments relatively high surface fill factors can be used across the entire roofing product, or in other embodiments, substantially only in the exposure area of the roofing product.

More than one type of granule can be used in the over-pressed nailing zone. For example, a combination of larger (e.g., #11 mesh) and smaller (e.g., #18 or #22 mesh) granules can be used. In some embodiments, the granules in the overpressed nailing zone are selected so that the appearance of the overpressed nailing zone is complementary to the top surface of the bituminous roofing substrate in the area adjacent to the overpressed nailing zone. As used herein L*, a* and b* are the color measurements for a given sample using the 1976 CIE color space. The strength in color space E* is defined as E*=(L*2+a*2+b*2)^{1/2}. The total color difference ΔE* between two articles is defined as ΔE*=(ΔL*2+Δa*2+Δb*2)^{1/2}, in which ΔL*, Δa* and Δb* are respectively the differences in L*, a* and b* for the two articles. L*, a* and b* values are measured using a HunterLab Model Labscan XE spectrophotometer using a 0° viewing angle, a 45° illumination angle, a 10° standard observer, and a D-65 illuminant. Lower L* values correspond to relatively darker tones. In such embodiments, if part or all of a overpressed nailing zone is not covered by an element or structure adhered thereto, it can complement the rest of the surface of the bituminous roofing substrate. In certain embodiments of the disclosure, the overpressed nailing zone has a ΔE*<30 compared to the top surface of the bituminous roofing substrate in the area adjacent to the overpressed nailing zone. In some embodiments, the over-pressed zone has a ΔE*<20 (or even <10) compared to the top surface of the bituminous roofing substrate in the area adjacent to the overpressed nailing zone. For example, when the overpressed nailing zone is coated with granules as described above, they can be of similar color, type, and/or distribution as those used in the area adjacent to the overpressed nailing zone. And as described above, in many embodiments, the granule type, distribution and coverage is substantially identical in the overpressed nailing zone and the first and second adjacent zones.

Another aspect of the disclosure is a roof comprising a roof deck and an overlapping array of the roofing shingles according to the disclosure disposed thereon. One such embodiment is shown in partial schematic plan view in FIG. 9. Roof 960 comprises roof deck 965 and an overlapping array of laminated roofing shingles 900 disposed thereon. Fasteners 968 (e.g., nails or screws) are driven through the nailing zone of each shingle, through an underlying shingle, and into the roof to secure the shingles in an overlapping array in which the headlap portions of the shingles are generally covered and the tab portions are generally exposed. As the person of ordinary skill in the art will appreciate, one or more underlayments can be positioned between a surface of the roof deck and the shingles 900. The person of ordinary skill in the art can use conventional accessories and methods to provide the roof decks of the disclosure.

Another aspect of the disclosure is a method for making the roofing shingles of the disclosure. The method includes:
disposing granules on a top surface of a bituminous substrate, including
   a first plurality of granules in a nailing zone disposed in a region of the headlap portion (e.g., a region in which an underlay sheet and an overlay sheet overlap),
   a second plurality of granules in a first adjacent zone disposed on the bituminous top surface adjacent to and in an up-shingle direction from the nailing zone, and
   a third plurality of granules in a second adjacent zone disposed on the bituminous top surface adjacent to and in a down-shingle direction from the nailing zone; and
pressing the granules into the top surface of the bituminous substrate, to form an overpressed nailing zone in which the first plurality of roofing granules are embedded in the bituminous top surface in a visually distinct manner as compared to (e.g., more deeply than) the second plurality of roofing granules and the third plurality of roofing granules; and
forming the granule-coated bituminous substrate into a roofing shingle having the overpressed nailing zone at a top surface in a headlap zone thereof.

Shingle layers can be manufactured, for example, using conventional methods, cut into overlay and underlay layers, laminated together (optionally using an adhesive layer) and/or cut into individual shingles. The granules can be coated onto bituminous roofing substrates using standard techniques, controlling the distance between the granule press and the bituminous roofing substrate to provide desired degrees of pressing in the various zones. The granules in the overpressed nailing zones can be pushed more deeply into the bituminous material in the granule coating process, for example, by first coating both the standard-pressed areas and the over-pressed zones with granules as is conventional, then, while the bituminous material is still soft, pushing the granules down further only in the over-pressed zones. The second pressing operation can also be performed with a separate heating of the substrate to soften the bituminous material. Alternatively, a granule press with the desired surface relief can be used in the initial coating process.

Thus, the granules, once dropped onto the bituminous top surface, can be pressed in any manner suitable to press granules in the overpressed nailing zone so as to be visually distinct from the first and second adjacent zones, e.g., by being pressed further into the bituminous top surface than the granules in the first and second adjacent zones, or by being tilted at a different overall average angle than the granules in the first and second adjacent zones. In some embodiments, the granules are pressed with a rotating drum that has a larger circumference in an area pressing the overpressed nailing zone than in the areas pressing the first and second adjacent zones. For example, a roller, a drum, an embosser, or the like with a raised or ridged surface can be used to overpress the shingle forming the overpressed nailing zone while the shingle is being assembled on a manufacturing line with a given line speed. In other embodiments, granules are first uniformly pressed with a drum of uniform circumference in the areas pressing the overpressed nailing zone and the first and second adjacent zones, and then the first plurality of granules are overpressed only in the overpressed nailing zone. In some embodiments, the roller, drum, embosser, or similar pressing instrument may have a circumferential velocity that is greater than or less than the line speed of the bituminous top layer during the overpressing process. In some exemplary embodiments, the overpressed portion of the shingle will have a different appearance than those adjacent zones of the shingle that are not overpressed, due to the differential velocity tilting the granules in the overpressed zone.

Consequently, the overpressed portion of the shingle forms a nailing zone indicator that can be readily and consistently applied to the shingle, without requiring application or removal of any additional materials or components. In such an embodiment, additional components or materials designed to delineate a nailing zone such as tapes, paints, markers, or lettering become unnecessary as a viewer can readily ascertain the nailing zone from visual inspection of the more deeply embedded roofing granules in the overpressed nailing zone than the regularly pressed roofing granules in the standard pressed adjacent zones of the laminated roofing shingle.

Overpressing the roofing granules to form the overpressed nailing zone is a cost effective and simplified alternative to delineating a nailing zone as compared to methods that require abrasion. Abrasion results in removing material that has already been applied to the shingle and requires such byproducts of the abrading process to be accounted for and reincorporated into the manufacturing process, or otherwise dealt with. Overpressing on the other hand, allows for the shingle manufacturing process to continuously move forward, does not remove components that were previously added, and does not result in the creation of additional byproducts to be dealt with.

Additional aspects of the disclosure are provided by the following enumerated embodiments, which can be combined and permuted in any number and in any combination not technically or logically inconsistent.

Embodiment 1. A roofing shingle having a headlap portion and a top surface:
wherein the roofing shingle includes an overpressed nailing zone disposed on the top surface of the shingle in the headlap portion thereof, a first adjacent zone on the top surface of the shingle adjacent to and in an up-shingle direction from the overpressed nailing zone, and a second adjacent zone disposed on the top surface of the shingle adjacent to and in a down-shingle direction from the overpressed nailing zone, the first and second adjacent zones being 5 mm in height; and
wherein the roofing granules include a first plurality of roofing granules disposed in the overpressed nailing zone; a second plurality of granules disposed in the first adjacent zone; and a third plurality of granules disposed in the second adjacent zone; and
wherein the first plurality of roofing granules are embedded in a bituminous top surface of the shingle in a visually distinct manner as compared to (e.g., more deeply than) the second plurality of roofing granules and the third plurality of roofing granules.
   Embodiment 2. The roofing shingle of embodiment 1, wherein the roofing shingle is a laminated roofing shingle comprising
   an underlay sheet having a top surface;
   an overlay sheet having a bituminous top surface and a bottom surface bonded to the top surface of the underlay sheet, the overlay sheet comprising a tab portion comprising at least one tab and at least one cutout, and a headlap portion, the overlay sheet further comprising roofing granules disposed on the bituminous top surface;
wherein the laminated roofing shingle includes an overpressed nailing zone disposed on the top surface of the overlay sheet overlapping a region of the headlap portion in which the underlay sheet and the overlay sheet overlap, a first adjacent zone on the top surface of the overlay sheet adjacent to and in an up-shingle direction from the overpressed nailing zone, and a second adjacent zone disposed on the top surface of the overlay sheet adjacent to and in an down-shingle direction from the overpressed nailing zone, the first and second adjacent zones being 5 mm in height; and
wherein the roofing granules include a first plurality of roofing granules disposed in the overpressed nailing zone; a second plurality of granules disposed in the first adjacent zone of the overlay sheet; and a third plurality of granules disposed in the second adjacent zone of the overlay sheet; and
wherein the first plurality of roofing granules are embedded in the bituminous top surface of the overlay sheet in a visually distinct manner as compared to (e.g., more deeply than) the second plurality of roofing granules and the third plurality of roofing granules.
   Embodiment 3. The roofing shingle according to embodiment 1 or embodiment 2, wherein in the overpressed nailing zone an average granule embed volume fraction is at least 0.5, the granule embed volume fraction for each roofing granule being the fraction of the roofing granule that is disposed beneath the level of the upper face of the bituminous top surface.
   Embodiment 4. The roofing shingle according to embodiment 1 or embodiment 2 wherein in the overpressed nailing zone an average granule embed volume fraction is at least 0.7.
   Embodiment 5. The roofing shingle according to embodiment 1 or embodiment 2 wherein in the overpressed nailing zone an average granule embed volume fraction is at least 0.85.
   Embodiment 6. The roofing shingle according to any of embodiments 1-5, wherein in the first and/or second adjacent zones an average granule embed volume fraction is at least 0.15 less (e.g., at least 0.2 less) than an average granule embed volume fraction of the overpressed nailing zone.
   Embodiment 7. The roofing shingle according to any of embodiments 1-5, wherein in the first and/or second adjacent zones an average granule embed volume fraction is at least 0.25 less (e.g., at least 0.3 less) than an average granule embed volume fraction of the overpressed nailing zone.
   Embodiment 8. The roofing shingle according to any of embodiments 1-7, wherein in the overpressed nailing zone, the average distance between the tops of the roofing granules and the bituminous top surface is 1.0 mm or less.
   Embodiment 9. The roofing shingle according to any of embodiments 1-7, wherein in the overpressed nailing zone, the average distance between the tops of the roofing granules and the bituminous top surface is 0.7 mm or less.
   Embodiment 10. The roofing shingle according to any of embodiments 1-7, wherein in the overpressed nailing zone, an average distance between the tops of the roofing granules and the bituminous top surface is 0.5 mm or less (e.g., 0.2 mm or less).
   Embodiment 11. The roofing shingle according to any of embodiments 1-10, wherein in the first and/or second adjacent zones an average distance between the tops of the roofing granules and the bituminous top surface is at least 0.2 mm more (e.g. at least 0.3 mm more) than an average distance between the tops of the roofing granules and the bituminous top surface in the overpressed nailing zone.
   Embodiment 12. The roofing shingle according to any of embodiments 1-10, wherein in the first and/or second adjacent zones an average distance between the tops of the roofing granules and the bituminous top surface is at least 0.4 mm more (e.g. at least 0.5 mm more) than an average distance between the tops of the roofing granules and the bituminous top surface in the overpressed nailing zone.
   Embodiment 13. The roofing shingle according to any of embodiments 1-12, wherein the overpressed nailing zone exhibits a 0.30 gram loss or less in a rub test as described in ASTM D-4977.
   Embodiment 14. The roofing shingle according to any of embodiments 1-12, wherein the overpressed zone exhibits a 0.20 gram loss or less in a rub test as described in ASTM D-4977.
   Embodiment 15. The roofing shingle according to any of embodiments 1-12, wherein the overpressed zone exhibits a 0.10 gram loss or less in a rub test as described in ASTM D-4977.
   Embodiment 16. The roofing shingle according to any of embodiments 1-15, wherein the first and/or second adjacent zones exhibits a loss in a rub test as described in ASTM D-4977 that is at least 0.2 grams more (e.g., at least 0.25 grams more) than a loss exhibited by the overpressed nailing zone.
   Embodiment 17. The roofing shingle according to any of embodiments 1-15, wherein the first and/or second adjacent zones exhibits a loss in a rub test as described in ASTM D-4977 that is at least 0.3 grams more (e.g., at least 0.35 grams more) than a loss exhibited by the overpressed nailing zone.
   Embodiment 18. The roofing shingle according to any of embodiments 1-17, wherein the first plurality of granules are of substantially the same color and distribution as the second and/or third pluralities of granules.
   Embodiment 19. The roofing shingle according to any of embodiments 1-17, wherein an overall surfacing of the overpressed nailing zone is substantially the same as an overall surfacing of the first adjacent zone and an overall surfacing of a second adjacent zone, i.e., the type and distribution of granules and other matter disposed on the bituminous top surface is substantially the same in the overpressed nailing zone as in the first and second adjacent zones.
   Embodiment 20. The roofing shingle according to any of embodiments 1-19, wherein the overpressed nailing zone extends substantially from a first lateral edge of the shingle or the overlay sheet to an opposing second lateral edge of the shingle or the overlay sheet.
   Embodiment 21. The roofing shingle according to any of embodiments 1-19, wherein the overpressed nailing zone does not extend substantially from a first lateral edge of the shingle or the overlay sheet to an opposing second lateral edge of the shingle or the overlay sheet.
   Embodiment 22. The roofing shingle according to embodiment 21, wherein the overpressed nailing zone includes a plurality of separate overpressed segments extending along a width of the shingle or the overlay sheet.
   Embodiment 23. The roofing shingle according to any of embodiments 1-22, wherein the overpressed nailing zone has a height measured in an up-shingle to down-shingle direction in the range of 10 mm to 50 mm.
   Embodiment 24. The roofing shingle according to any of embodiments 1-23, wherein the overpressed nailing zone includes a first region and a second region disposed in a down-shingle direction from the first region, the first region and the second region defining therebetween a non-overpressed nailing zone.
   Embodiment 25. The roofing shingle according to embodiment 24, wherein the non-overpressed nailing zone has a height measured in an up-shingle to down-shingle direction in the range of 10 mm to 50 mm.
   Embodiment 26. The roofing shingle according to embodiment 24 or embodiment 25, wherein the first and second regions have heights measured in an up-shingle to down-shingle direction in the range of 3 mm to 20 mm.
   Embodiment 27. The roofing shingle according to any of embodiments 1-26, wherein the first plurality of granules are substantially uniformly pressed into the bituminous top surface throughout the overpressed nailing zone.
   Embodiment 28. The roofing shingle according to any of embodiments 1-26, wherein the first plurality of granules are not substantially uniformly pressed into the bituminous top surface throughout the overpressed nailing zone.
   Embodiment 29. The roofing shingle according to embodiment 28, wherein the first plurality of granules are pressed into the bituminous top surface with a periodically varying profile along a width of the shingle or overlay sheet.
   Embodiment 30. The roofing shingle according to embodiment 29, wherein the first plurality of granules are pressed into the bituminous top surface in a wave form pattern such that the amplitude of the wave defines the width of the nailing zone.
   Embodiment 31. The roofing shingle according to any of embodiments 1-30, wherein the shingle is rectangular.
   Embodiment 32. The roofing shingle according to any of embodiments 1-31, wherein the first plurality of granules are embedded more deeply in the bituminous top surface than the second plurality of granules and the third plurality of granules.
   Embodiment 33. The roofing shingle according to any of embodiments 1-32, wherein the first plurality of granules are tilted at a different average angle than the second plurality of granules and the third plurality of granules.
   Embodiment 34. A roof comprising a roof deck and an overlapping array of the roofing shingles according to any of embodiments 1-33 disposed thereon.
   Embodiment 35. A method for making the roofing shingle any of embodiments 1-34, the method comprising:
   disposing granules on a top surface of a bituminous substrate, including
      a first plurality of granules in a nailing zone disposed in a region of the headlap portion (e.g., a region in which an underlay sheet and an overlay sheet overlap),
      a second plurality of granules in a first adjacent zone disposed on the bituminous top surface adjacent to and in an up-shingle direction from the nailing zone, and
      a third plurality of granules in a second adjacent zone disposed on the bituminous top surface adjacent to and in a down-shingle direction from the nailing zone; and
   pressing the granules into the top surface of the bituminous substrate, to form an overpressed nailing zone in which the first plurality of roofing granules are embedded in the bituminous top surface in a visually distinct manner as compared to (e.g., more deeply than) the second plurality of roofing granules and the third plurality of roofing granules; and
   forming the granule-coated bituminous substrate into a roofing shingle having the overpressed nailing zone at a top surface in a headlap zone thereof.
      Embodiment 36. The method of embodiment 35, wherein the granules are pressed with a rotating drum that has a larger circumference in an area pressing the overpressed nailing zone than in the areas pressing the first and second adjacent zones.
      Embodiment 37. The method of embodiment 35, wherein the granules are first uniformly pressed with a drum of uniform circumference in the areas pressing the overpressed nailing zone and the first and second adjacent zones, and then the first plurality of granules are overpressed with a narrow drum.
      Embodiment 38. The method of embodiment 37, wherein the narrow drum has a circumferential velocity that is greater than or less than a line speed of the bituminous top layer during the overpressing.

What is claimed is:

1. A roofing shingle having a headlap portion and a top surface:
wherein the roofing shingle includes an overpressed nailing zone disposed on the top surface of the shingle in the headlap portion thereof, a first adjacent zone on the top surface of the shingle adjacent to and in an up-shingle direction from the overpressed nailing zone, and a second adjacent zone disposed on the top surface of the shingle adjacent to and in a down-shingle direction from the overpressed nailing zone, the first and second adjacent zones being 5 mm in height; and
wherein the roofing granules include a first plurality of roofing granules disposed in the overpressed nailing zone; a second plurality of granules disposed in the first adjacent zone; and a third plurality of granules disposed in the second adjacent zone; and
wherein the first plurality of roofing granules are embedded in a bituminous top surface of the shingle in a visually distinct manner as compared to the second plurality of roofing granules and the third plurality of roofing granules.

2. The roofing shingle of claim 1, wherein the roofing shingle is a laminated roofing shingle comprising
an underlay sheet having a top surface;
an overlay sheet having a bituminous top surface and a bottom surface bonded to the top surface of the underlay sheet, the overlay sheet comprising a tab portion comprising at least one tab and at least one cutout, and a headlap portion, the overlay sheet further comprising roofing granules disposed on the bituminous top surface;
wherein the laminated roofing shingle includes an overpressed nailing zone disposed on the top surface of the overlay sheet overlapping a region of the headlap portion in which the underlay sheet and the overlay sheet overlap, a first adjacent zone on the top surface of the overlay sheet adjacent to and in an up-shingle direction from the overpressed nailing zone, and a second adjacent zone disposed on the top surface of the overlay sheet adjacent to and in an down-shingle direction from the overpressed nailing zone, the first and second adjacent zones being 5 mm in height; and
wherein the roofing granules include a first plurality of roofing granules disposed in the overpressed nailing zone; a second plurality of granules disposed in the first adjacent zone of the overlay sheet; and a third plurality of granules disposed in the second adjacent zone of the overlay sheet; and
wherein the first plurality of roofing granules are embedded in the bituminous top surface of the overlay sheet in a visually distinct manner as compared to the second plurality of roofing granules and the third plurality of roofing granules.

3. The roofing shingle according to claim 1, wherein in the overpressed nailing zone an average granule embed volume fraction is at least 0.7, the granule embed volume fraction for each roofing granule being the fraction of the roofing granule that is disposed beneath the level of the upper face of the bituminous top surface.

4. The roofing shingle according to claim 1, wherein in the first and/or second adjacent zones an average granule embed volume fraction is at least 0.25 less than an average granule embed volume fraction of the overpressed nailing zone.

5. The roofing shingle according to claim 1, wherein in the overpressed nailing zone, the average distance between the tops of the roofing granules and the bituminous top surface is 0.7 mm or less.

6. The roofing shingle according to claim 1, wherein in the first and/or second adjacent zones an average distance between the tops of the roofing granules and the bituminous top surface is at least 0.4 mm more than an average distance between the tops of the roofing granules and the bituminous top surface in the overpressed nailing zone.

7. The roofing shingle according to claim 1, wherein the overpressed zone exhibits a 0.20 gram loss or less in a rub test as described in ASTM D-4977.

8. The roofing shingle according to claim 1, wherein the first and/or second adjacent zones exhibits a loss in a rub test as described in ASTM D-4977 that is at least 0.3 grams more than a loss exhibited by the overpressed nailing zone.

9. The roofing shingle according to claim 8, wherein the first plurality of granules are of substantially the same color and distribution as the second and/or third pluralities of granules.

10. The roofing shingle according to claim 1, wherein an overall surfacing of the overpressed nailing zone is substantially the same as an overall surfacing of the first adjacent zone and an overall surfacing of a second adjacent zone, i.e., the type and distribution of granules and other matter disposed on the bituminous top surface is substantially the same in the overpressed nailing zone as in the first and second adjacent zones.

11. The roofing shingle according to claim 1, wherein the overpressed nailing zone extends substantially from a first lateral edge of the shingle or the overlay sheet to an opposing second lateral edge of the shingle or the overlay sheet.

12. The roofing shingle according to claim 1, wherein the overpressed nailing zone does not extend substantially from a first lateral edge of the shingle or the overlay sheet to an opposing second lateral edge of the shingle or the overlay sheet.

13. The roofing shingle according to claim 12, wherein the overpressed nailing zone includes a plurality of separate overpressed segments extending along a width of the shingle or the overlay sheet.

14. The roofing shingle according to claim 1, wherein the overpressed nailing zone has a height measured in an up-shingle to down-shingle direction in the range of 10 mm to 50 mm.

15. The roofing shingle according to claim 1, wherein the first plurality of granules are not substantially uniformly pressed into the bituminous top surface throughout the overpressed nailing zone.

16. The roofing shingle according to claim 15, wherein the first plurality of granules are pressed into the bituminous top surface with a periodically varying profile along a width of the shingle or overlay sheet.

17. The roofing shingle according to claim 1, wherein the first plurality of granules are embedded more deeply in the bituminous top surface than the second plurality of granules and the third plurality of granules.

18. The roofing shingle according to claim 1, wherein the first plurality of granules are tilted at a different average angle than the second plurality of granules and the third plurality of granules.

19. A roof comprising a roof deck and an overlapping array of the roofing shingles according to claim 1 disposed thereon.

20. A method for making the roofing shingle of claim 1, the method comprising:
disposing granules on a top surface of a bituminous substrate, including
a first plurality of granules in a nailing zone disposed in a region of the headlap portion,
a second plurality of granules in a first adjacent zone disposed on the bituminous top surface adjacent to and in an up-shingle direction from the nailing zone, and
a third plurality of granules in a second adjacent zone disposed on the bituminous top surface adjacent to and in a down-shingle direction from the nailing zone; and
pressing the granules into the top surface of the bituminous substrate, to form an overpressed nailing zone in which the first plurality of roofing granules are embedded in the bituminous top surface in a visually distinct manner as compared to the second plurality of roofing granules and the third plurality of roofing granules; and
forming the granule-coated bituminous substrate into a roofing shingle having the overpressed nailing zone at a top surface in a headlap zone thereof.
